(19) United States
(12) Patent Application Publication
(10) Pub. No.: US 2006/0177217 A1
(43) Pub. Date: Aug. 10, 2006

(54) Dome with optical correction

(76) Inventor: Peter Opmeer, Eindhoven (NL)

Correspondence Address: STRIKER, STRIKER & STENBY, 103 EAST NECK ROAD, HUNTINGTON, NY, 11743, US

(21) Appl. No.: 11/351,086

(22) Filed: Feb. 9, 2006

(30) Foreign Application Priority Data
Feb. 6, 2005 (EP) 05104771.0

(51) Int. Cl. G03B 17/00

(52) U.S. Cl. 396/427

(57) ABSTRACT

A transparent dome (114) for use in a vandal-proof surveillance camera system (110) is proposed. The transparent dome (114) comprises a transparent optical material (138), which itself comprises an inner surface (116) and an outer surface (118). Both surfaces (116, 118) are essentially rotational symmetrical and exhibit non-spherical shapes. Further, a vandal-proof surveillance camera system (110) comprising a transparent dome (114) according to the invention and a camera (128) being pivotably mounted inside the transparent dome (114) is proposed.

The invention refers to a transparent dome for use in a surveillance camera system, mainly for use in a vandal-proof surveillance camera system. Further, the invention refers to a vandal-proof surveillance camera system comprising a transparent dome according to the invention. Transparent domes and vandal-proof surveillance camera systems can be used, i.e., for indoor and/or outdoor surveillance, such as surveillance of public or private buildings or surveillance of vehicles.

### PRIOR ART

With the development of modern camera systems, such as digital camera systems, optical surveillance becomes more and more widespread in various fields of technology. Thus, surveillance camera systems nowadays can be found for indoor and/or outdoor surveillance purposes within public or private buildings or within automotive technology, such as for passenger detection and observation.

In some of these applications, the camera systems are subject to harsh conditions. Thus, for outdoor surveillance purposes, the camera systems typically are subject to rough environmental conditions, such as weather conditions (e.g. rain or snow). For surveillance application purposes, especially of public buildings, the camera systems are subject to mechanical strain, such as exposure to acts of human vandalism, scratches or mechanical shocks.

In order to protect the camera systems and to extend the lifetime of the systems, surveillance camera systems using a transparent dome as a protection against environmental stress or exposure to human vandalism are known from the state of the art. JP 2000 156810. A describes a dome cover, a dome video camera and device forming a dome cover. The dome is injection-molded of acrylic resin having an optical transparency. The inner surface and the outer surface of the dome cover have a spherical shape. The centers of these spherical surfaces are offset by 0.5 mm.

Nevertheless, optical domes known from prior art usually exhibit various shortcomings or disadvantages. These shortcomings and disadvantages usually are connected with the fact that a camera (including an optical lens system) is placed pivotably within the optical dome. This pivotable mounting of the camera inside the dome ensures that the camera may be aimed arbitrarily, in order to acquire images of arbitrary solid angles selected by the person operating the camera. Either manually or using a pivoting motor, the camera may be directed to point towards a selected object or towards the desired solid angle of space to be monitored.

Typically, materials such as polycarbonate are used as transparent materials for the transparent domes. Nevertheless, especially when pointing the camera through the transparent dome in a horizontal or nearly horizontal direction, these polycarbonate domes cause color shifts of the images acquired by the camera. Thus, depending on the direction of the optical axis of the camera, especially when acquiring horizontal or near-horizontal views, the image quality of the image acquired by the camera is strongly affected by the wave length. Thus, image distortion depending on the wave length and the angle of the optical axis are unavoidable.

These image distortions are rather significant when using a cylindrically shaped transparent dome extent, i. e. a dome including a cylindrical portion and a spherical cap. Even the spherically shaped transparent domes as described in JP 2000 156810 A do not completely solved the distortion problem. Further, spherically shaped transparent domes exhibit the disadvantage, that horizontal views, i.e. views parallel or nearly parallel to the ceiling, are rather difficult.

### ADVANTAGES OF THE INVENTION

The present invention therefore discloses a transparent dome for use in vandal-proof surveillance camera systems avoiding the disadvantages of systems known from the art. Thus, a surveillance camera system is be disclosed, which, while keeping the image quality to an acceptable level, exhibits the benefit of allowing a view along the ceiling surface to which the transparent dome camera is mounted.

The transparent dome comprises a transparent optical material which itself comprises an inner surface and an outer surface. The outer surface is essentially rotationally symmetrical about a first symmetry axis, wherein a first apex of the outer surface is located on the first symmetry axis. The inner surface is essentially rotationally symmetrical about a second symmetry axis, wherein a second apex of the inner surface is located on the second symmetry axis.

Preferably, the first symmetry axis and the second symmetry axis are identical. Nevertheless, it is preferred if the first symmetry axis and the second symmetry axis are shifted by no more than 0.1 mm, most preferably by no more than 0.05 mm. Further, it is preferred if the symmetry axes are tilted by no more than 2 mrad, most preferably by no more than 1 mrad, with respect to each other.

The optical material exhibits an essentially ring-shaped mounting surface, which can be used in order to mount the transparent dome to a ceiling surface or any other flat surfaces or to a separate mounting block.

The transparent dome according to the invention is distinguished from transparent domes known from the state of the art by the shape of the inner and the outer surface of the optical material. Both, the outer surface and the inner surface, exhibit non-spherical shapes.

Preferably, the inner surface and/or the outer surface essentially exhibit the shape of even polynomial functions. Most preferably, these even polynomial functions are order not exceeding eighteen, preferably not exceeding sixteen and most preferably not exceeding fourteen. By “an order not exceeding fourteen” it is to be understood, that polynomial coefficients of higher order than fourteen are negligible (e.g. at least two orders of magnitude smaller) than the polynomial coefficients of the order between two and fourteen. Most preferably, the polynomial coefficients (of dimensionless) of the fourth order and of higher orders are by at least three orders of magnitude and most preferably by at least four orders of magnitude smaller than the second order polynomial coefficients of the polynomial functions of the inner and outer surface.

Most preferably, the optical material comprises poly-polymethyl methacrylate (PMMA) and/or polycarbonate. Most preferably, the optical material exhibits an index of refraction of approximately n=1.65 at a wave length of approximately 540 nm. It is advantageous if the optical material is produced in a way that the surface roughness of both the inner and the outer surface is better than 3 diamonds, also denoted as P3 (according to ISO-10110, polish quality), in the optical region. The transparent dome should not contain hazy parts in the optical region.

According to a preferred embodiment of the invention, the inner surface and the outer surface of the optical material are shaped that the transparent dome, i.e. the optical material, exhibits a thickness variation. The thickness of the optical material in the following is measured perpendicular to the outer surface of the optical material of the transparent dome.

Thus, the thickness variation from the first apex to the ring-shaped mounting surface may have a maximum of at least 2% variation (i.e. maximum thickness minus minimum thickness, divided by maximum thickness), preferably at least 6% and most preferably 8%. Preferably, the thickness variation does not exceed 10%, depending on the starting point of the optical calculations and other constraints of the optical design. The thickness may exhibit a maximum, preferably a global maximum, at the first apex. Further, the thickness of the optical material may be a polynomial function of the separation x of the point of measurement on the outer surface of the optical material from the first symmetry axis.

Further, a vandal-proof surveillance camera system comprising a transparent dome according to one of the embodiments described above is disclosed, which further comprises a camera, which is mounted inside the transparent dome. As disclosed above, this camera may comprise an optical sensing system (e.g. a CCD chip or any other imaging system), as well as a lens system. Most preferably, the lens system exhibits an overall focal length greater than 15 mm. The camera is pivotably mounted about a pivot point inside the transparent dome. Preferably (but not necessarily), the pivot point is situated on the first or most preferably the second symmetry axis (whereby the first and the second symmetry axis, as disclosed above, preferably are identical). For the positioning of the pivot point, tolerances of 2 mm, preferably 1 mm, are acceptable. Thus, the pivot point may be situated e.g. 1 mm of the first or second symmetry axis.

The pivot point of the camera may be shifted or arbitrarily chosen along the first or second symmetry axis. Most preferably, the pivot point is chosen at a location along the first or second symmetry axis in a way that the separation between the pivot point and the inner surface of the optical material is approximately constant in any direction accessible by the camera.

Thus, the pivot point may be chosen in a way that the distance between the pivot point and an arbitrary point on the inner surface located at a distance x from the first or second symmetry axis is a function of x, wherein the graph of this function shows a maximum at x=0. In other words, the distance between pivot point and the inner surface may be greatest for looking straight down from the pivot point. Most preferably, as indicated above, this maximum is rather “flat” maximum, which means, that the variations between the pivot point and an arbitrary point on the inner surface do not exceed 25%, most preferably 15%, for the angles accessible by camera inside the transparent dome.

The camera system disclosed above, using the transparent dome according to one of the embodiments as described, has shown to exhibit a good image quality for lenses with focal lengths up to 35 mm and for lens openings up to F/2 (F being the diaphragm number, so diaphragm number=2): Mainly the wall thickness profile of the optical dome as disclosed above makes possible viewing angles beyond ceiling view, e.g. viewing angles (angle between first or second symmetry axis and the direction of view of the camera) of 95° and more.

Still, the variation of the optical properties resides within tolerable values for these viewing angles. Thus, colour shift and image distortions for these viewing angles exhibit a rather small variation over the range of obtainable viewing angles. This allows e.g. four automatic pattern recognition, such as using image processing routines for detecting certain objects within images acquired by surveillance cameras using the transparent dome according to the invention.

### DRAWINGS

The invention will be described in more details with reference to the drawings given below, in which:

FIGS. 1A to 1C show an exemplary embodiment of a vandal-proof surveillance camera system, the camera pointing into three different directions;

FIG. 2 shows a thickness profile of a transparent dome to be used in a surveillance camera according to FIGS. 1A to 1C;

FIG. 3 shows the thickness profile of the transparent dome as a function of the viewing angle of the embodiment according to FIG. 2; and

FIG. 4 the thickness profile of the transparent dome according to FIG. 2, given as a function of the distance x from the symmetry axis.

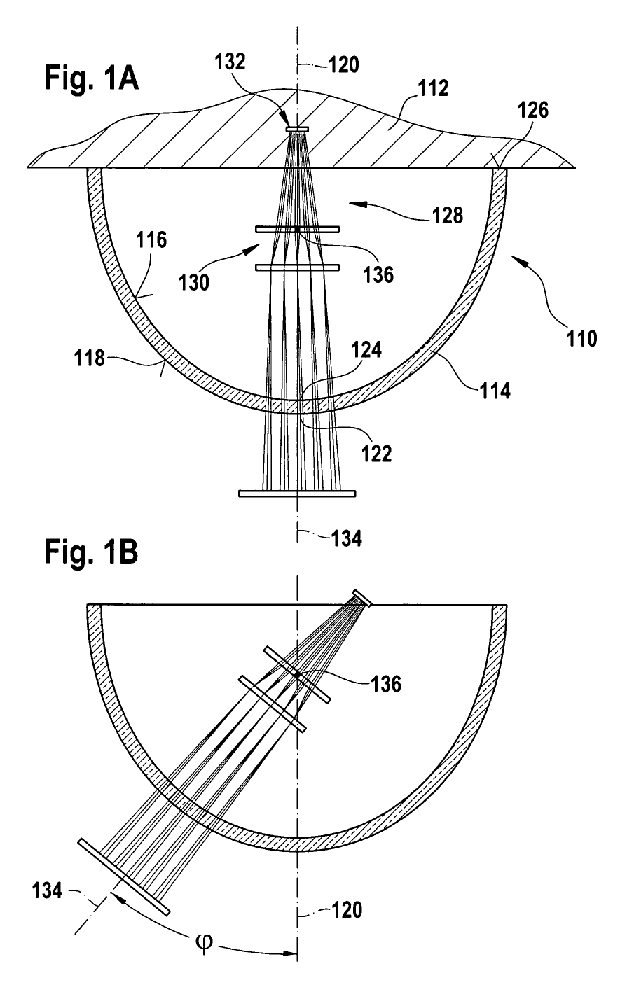

In FIGS. 1A to 1C a preferred embodiment of a vandal-proof surveillance camera system 110, which can be mounted to a ceiling 112, is depicted. The surveillance camera system 110 comprises a transparent dome 114, which will be described in more detail below. The transparent dome 114 comprises an inner surface 116 and an outer surface 118, which both exhibit conical shapes according to a polynomial function as described in more detail below. Both, the inner surface 116 and the outer surface 118, are rotationally symmetrical about a symmetry axis 120. Thus, as described above, in this preferred embodiment the first symmetry axis of the outer surface 118 and the second symmetry axis of the inner surface 116 are identical. Further, the outer surface 118 exhibits a first apex 122 situated on the symmetry axis 120. Similarly, the inner surface 116 comprises a second apex 124, situated on the symmetry axis 120, too.

Further, the transparent dome 114 comprises a ring-shaped mounting surface 126, which terminates the transparent dome 114 in an upward direction. The transparent dome 114 may be directly mounted to the ceiling 112 via this ring-shaped mounting surface, or an additional mounting block may be mounted in between the transparent dome 114 and the ceiling 112 which e.g. may comprise electronics and/or optical components of the surveillance camera system 110. Further, the transparent dome 114 may be mounted on a camera housing, which is part of a camera 128. The camera 128 may be mounted to the ceiling 112 or a wall using a separate mounting box or mounting block.

The surveillance camera system 110 according to the exemplary embodiment in FIGS. 1A to 1C further comprises the camera 128. This camera 128 is only symbolically depicted in FIGS. 1A to 1C and comprises a lens system 130 and an image detector 132.

Cameras 128 like the one depicted in FIGS. 1A to 1C are known to the person skilled in the art.

The camera 128 according to FIGS. 1A to 1C has an optical axis 134. The camera 128 is pivotably mounted about a pivot point 136. For optical calculations and design, this pivot point 136 is the starting point. In FIGS. 1A to 1C, the pivot point 136 is located on the symmetry axis 120—which not necessarily has to be the case. The camera 128 may be rotated about this pivot point 136, either manually (e.g. by a surveillance technician) or using a motorized positioning system. It has to noted, that the optical components of the camera 128 are not necessarily drawn to the scale, which explains that the image detector 132 in FIGS. 1A and 1B may be located within the ceiling 112. Further, a “perfect” lens system 130 is symbolically used in the optical design, in order to calculate and to take into account lens aberrations of the transparent dome 114. With a “real” lens system 130, the image detector typically resides within the region of the transparent dome 114 rather than the ceiling 112.

In FIGS. 1A to 1C different rotational positions of the camera 128 a depicted. The angle between the symmetry axis 120 and the optical axis 134 of the camera 128 is denoted by φ. By definition, in FIG. 1A, wherein the camera 128 is directed straight down from the ceiling 112, the angle φ equals zero. In FIG. 1B, a positioning of the camera 128 exhibiting an angle φ of approximately 40° is depicted. In FIG. 1C, the so-called “beyond ceiling view” is depicted, which, in this case, comprises an angle of 95° between optical axis 134 and symmetry axis 120. The grate advantage of the surveillance camera system 110 using the conically-shaped transparent dome 114 according to FIGS. 1A to 1C is that ceiling-views of angles φ≧90° may be achieved without major image distortions or image deteriorations.

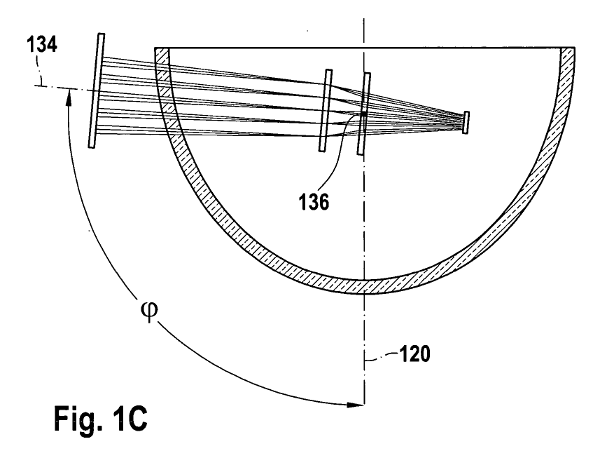

In FIG. 2, a preferred embodiment of the transparent dome 114 of the surveillance camera system 110 according to FIGS. 1A to 1C is depicted. The transparent dome 114 comprises an optical material 138, which, in this exemplary embodiment is made of polycarbonate. Alternatively, a PMMA or other transparent materials, such as transparent plastic materials or glasses, may be used.

FIG. 2 shows several graphs as functions of the distance x (given in mm) between an arbitrary point and the symmetry axis 120, which, in this figure, is identical to the y-axis. First, in FIG. 2 the inner surface 116 and the outer surface 118 are depicted as functions of the distance x. In this graph according to FIG. 2, the origin of the y-axis. has arbitrarily been chosen to be identical to the first apex 122. The thickness of optical material 138 along the symmetry axis 120, i.e. the distance between the first apex 122 and the second apex 124, in this preferred embodiment, has been chosen to be 3.20 m. Deviations of approximately up to 0.2 mm are tolerable.

The functional shape of the inner surface 116 and the outer surface 118 was optimized by minimizing optical distortions and chromatically apparitions over the visible spectrum and the near infrared spectrum using commercially available optical optimization software. Thus, for this preferred embodiment of the invention, the outer surface 118 was chosen to have a theoretical shape according to the following function:
o(x)=0.011138137x²+6.454381·10⁻⁷x⁴+3.5837465·10⁻⁹x⁶−3.2059279·10⁻¹²x⁸+1.6916882·10⁻¹⁵x¹⁰−3.7017898·10⁻¹⁹x¹²+2.8714374·10⁻²³x¹⁴ (1)

Similarly, the inner surface 116 was chosen to have a theoretical shape according to the following function:
i(x)=0.011912547x²+5.5535209·10⁻⁷x⁴+5.7019319·10⁻⁹x⁶−6.3174385·10⁻¹²x⁸+4.1409087·10⁻¹⁵x¹⁰−1.2425797·10⁻¹⁸x¹²+1.5271156·10⁻²²x¹⁴+3.20 (2)

Nevertheless, since these are theoretical functions, variations in the functional values o(x) and/or i(x) of approximately ±0.05 mm are estimated to be tolerable, most preferably 0.02 mm, still leading to tolerable optical results.

Further, in FIG. 2 the pivot point 136 on the symmetry axis 120 is depicted. In this preferred exemplary embodiment, according to FIG. 2, the pivot point 136 was chosen to be at a y-position of 49.0 mm above the first apex 122.

Further various viewing directions are indicated in FIG. 2 by virtual “viewing rays” 140. Each of these rays 140 includes an angle of φ with the symmetry axis 120, as already mentioned in FIGS. 1A to 1C. Each of these viewing rays 140 hits the inner surface 116 of the optical material 138 at an individual point A. The distance between the pivot point 136 and point A depends on the angle φ.

Graph 142 depicts the separation between the pivot point 136 and point A, i. e. the length of the viewing rays 140, as a function of the distance between point A and the symmetry axis 120, i.e. as a function of the x-coordinate of point A. As can be seen, for this choice of the pivot point 136 as depicted in FIG. 2 graph 142 exhibits rather flat maximum 144 on the symmetry axis 120, i.e. at x=0. At approximately x=40 mm, which corresponds to an angle of φ=70°, graph 142 exhibits a minimum. For distances x>40 mm, graph 142 rises significantly. Nevertheless, for angles up to about 95°, the variation in the distance 142 between the pivot point 136 and the inner surface 116 shows a variation not exceeding 15% to 20%. The knowledge of the position of the minimum of graph 142 is an important factor for mechanical design of the outer dimensions of the camera 128, in order to avoid collision between the camera 128 and the transparent dome 114 during rotation of the camera 128.

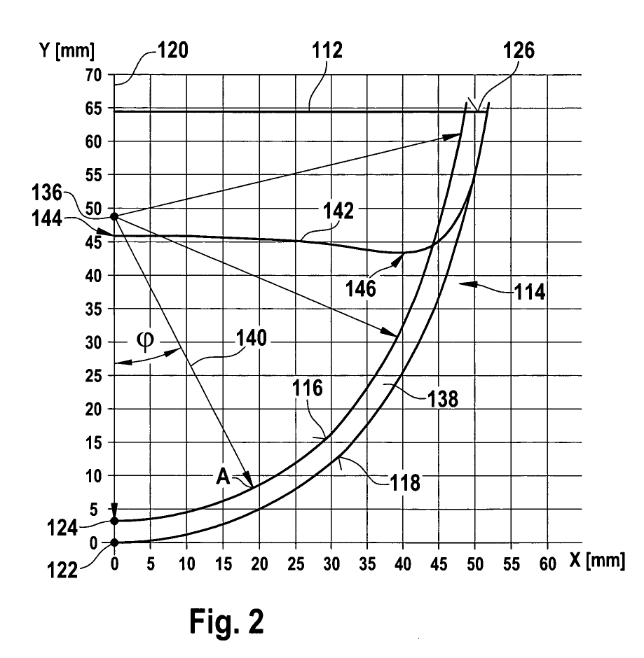

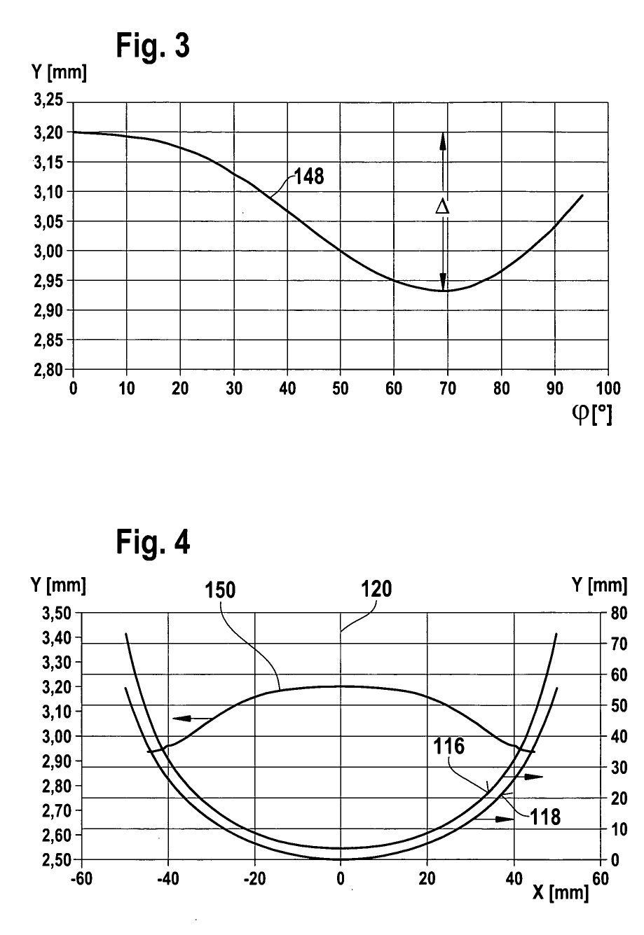

In FIGS. 3 and 4, the thickness variation of the optical material 138 of the transparent dome 140 according to the preferred embodiment as shown in FIG. 2 is depicted in two different modes. Thus, in FIG. 3, the thickness (y-axis, given in mm) is depicted as a function of the angle φ between the symmetry axis 120 and the virtual viewing ray 140 as depicted in FIG. 2. Here, as in FIG. 4, the thickness is measured perpendicularly to the outer surface 118.

In FIG. 4, the thickness (y-axis, given in mm) of the optical material 138 is given as a function of the distance between a point of measurement on the outer surface 118 and the symmetry axis 120 (graph 150). Thus, graph 148 in FIG. 3 and graph 150 in FIG. 4 both describe the thickness of the optical material 138 in different coordinate systems.

Further, in FIG. 4, the inner surface. 116 and the outer surface 118 of the optical material 138 are depicted again, as a function of the distance x from the symmetry axis 120. The right y-axis (given in mm) refers to graphs 116 and 118.

As can be seen from FIGS. 3 and 4, graphs 148 and 150, both denoting the thickness of the optical material 138, exhibit a maximum at φ=0 or x=0, respectively. At approximately φ=70° or x=40 mm, respectively, the thickness 148, 150 exhibits a minimum. As depicted in FIG. 3, the difference Δ between the minimum and the maximum is approximately 0.27 mm. Thus, the overall variation of the thickness in this exemplary embodiment is 0.27 mm divided by 3.20 mm, which corresponds to approximately 8.4%. This thickness variation as depicted in FIGS. 3 and 4 is an important feature of the present invention and contributes to the good optical qualities of the transparent dome 114 according to the invention. The thickness function can be calculated from the functions of the outer surface and the inner surface, as given by formula (1) and (2) (see above).

1-10. (canceled)

11. A transparent dome for use in a vandal-proof surveillance camera system, comprising a transparent optical material having an inner surface and an outer surface, said outer surface being essentially rotationally symmetrical about a first symmetry axis and having a first apex located on said first symmetry axis, said inner surface being essentially rotationally symmetrical about a second symmetry axis and having a second apex located on said second symmetry axis, said first symmetry axis and said second symmetry axis being essentially parallel, said outer surface and said inner surface exhibiting non-spherical shapes.

12. A transparent dome as defined in claim 11, wherein at least one of said surfaces essentially exhibits a shape of even polynomial functions o(x), i(x).

13. A transparent dome as defined in claim 12, wherein said polynominal functions o(x), i(x) is of an order not exceeding 18.

14. A transparent dome as defined in claim 12, wherein said polynominal functions o(x), i(x) is of an order not exceeding 16.

15. A transparent dome as defined in claim 12, wherein said polynominal functions o(x), i(x) is of an order not exceeding 14.

16. A transparent dome as defined in claim 12, wherein dimensional polynominal coefficients of the polynominal functions o(s), i(x) of a fourth order and of higher order are by at least three orders of magnitude smaller than second order polynominal coefficients of the polynominal functions o(x), i(x).

17. A transparent dome as defined in claim 12, wherein dimensional polynominal coefficients of the polynominal functions o(s), i(s) of a fourth order and of higher order are by at least four orders of magnitude smaller than second order polynominal coefficients of the polynominal functions o(x), i(x).

18. A transparent dome as defined in claim 11, wherein said inner surface and said outer surface are shaped so that said transparent optical material exhibits a thickness variation.

19. A transparent dome as defined in claim 11, wherein a relative thickness variation over the transparent material is at least 2%.

20. A transparent dome as defined in claim 11, wherein a relative thickness variation over the transparent material is at least 6%.

21. A transparent dome as defined in claim 11, wherein a relative thickness variation over the transparent material is at least 8%.

22. A transparent dome as defined in claim 11, wherein a relative thickness variation over the transparent material does not exceed 10%.

23. A transparent dome as defined in claim 11, wherein a thickness of the transparent material exhibits a maximum at said first apex.

24. A transparent dome as defined in claim 11, wherein a thickness of the transparent material exhibits a global maximum at said first apex.

25. A transparent dome as defined in claim 11, wherein a thickness of the transparent material at a point on said outer surface being separated by a distance x from said first symmetry axis is a polynominal function (f)x.

26. A vandal-proof surveillance camera system, comprising a transparent dome having a transparent optical material having an inner surface and an outer surface, said outer surface being essentially rotationally symmetrical about a first symmetry axis and having a first apex located on said first symmetry axis, said inner surface being essentially rotationally symmetrical about a second symmetry axis and having a second apex located on said second symmetry axis, said first symmetry axis and said second symmetry axis being essentially parallel, said outer surface and said inner surface exhibiting non-spherical shapes; and a camera being mounted inside said transparent dome, said camera being pivotable about a pivot point.

27. A vandal-proof surveillance camera system as defined in claim 28, wherein said pivot point is situated on said second symmetry axis.
